(19) United States
(12) Patent Application Publication
(10) Pub. No.: US 2007/0171775 A1
(43) Pub. Date: Jul. 26, 2007

(54) Objective lens driving device

(75) Inventor: Kenji Iwamoto, Higashihiroshima-shi (JP)

Correspondence Address: MORRISON & FOERSTER LLP, 1650 TYSONS BOULEVARD, SUITE 400, MCLEAN, VA, 22102, US

(73) Assignee: SHARP KABUSHIKI KAISHA, Osaka-shi (JP)

(21) Appl. No.: 11/651,080

(22) Filed: Jan. 9, 2007

(30) Foreign Application Priority Data
Jan. 26, 2006 (JP) 2006-018142

(51) Int. Cl. G11B 7/00

(52) U.S. Cl. 369/44.15; 369/44.22

(57) ABSTRACT

An objective lens driving device include: a lens holder, which holds an objective lens that converges light of a light source so that information is recorded or reproduced; and bar-like elastic supporting wires, which connect the lens holder to a wire supporting base. The objective lens driving device is arranged as follows: each of the supporting wires has at least one bent portion extending in different axial directions, and is included in a flat surface parallel to a flat surface including an optical axis of the objective lens.

This Nonprovisional application claims priority under 35 U.S.C. § 119(a) on Patent Application No. 018142/2006 filed in Japan on Jan. 26, 2006, the entire contents of which are hereby incorporated by reference.

### FIELD OF THE INVENTION

The present invention relates to an objective lens driving device that is to be provided in an optical pickup apparatus in which recording or reproduction of information is carried out with respect to a recoding surface of an optical information recording medium.

### BACKGROUND OF THE INVENTION

For example, an optical pickup apparatus, in which recording or reproduction of information is carried out with respect to an optical information recoding medium such as an optical disk, is provided with an objective lens driving device. The objective lens driving device causes an objective lens to converge light of a light source as a light spot on a recording surface of the optical information recording medium, and carries out focusing and positioning of the light spot. In the optical pickup apparatus, recording or reproduction of information is carried out with respect to an optical information recording medium by using the light thus converged.

Generally, an objective lens driving device includes a lens holder holding an objective lens, a supporting substrate for supporting the lens holder, and a plurality of elastic members for allowing the supporting substrate to support the lens holder. The lens holder includes driving means for causing the lens holder to move in a focus direction and in a tracking direction. Further, the elastic members connect the lens holder to the supporting substrate so that the lens holder can be moved in a focus direction and in a tracking direction.

Thus, the objective lens driving device causes the lens holder to move in a focus direction and in a tracking direction, and carries out focusing and positioning of a light spot with respect to a recording surface of an optical information recording medium.

An arrangement of a conventional objective lens driving device is disclosed in Japanese Unexamined Utility Model Publication No. 72318/1992 (Jitsukaihei 4-72318; published on Jun. 25, 1992). An objective lens driving device having the same arrangement as the arrangement described in the publication will be described below with reference to FIG. 9. FIG. 9 is a perspective view schematically showing an arrangement of a conventional objective lens driving device 101. Note that the focus direction refers to a direction of an optical axis of an objective lens and that the tracking direction refers to a radial direction of a disk optical information recording medium.

As shown in FIG. 9, the conventional objective lens driving device 101 is arranged so as to include a lens holder 102, supporting wires 103a, 103b, 103c, and 103d, a substrate 104, a wire supporting base 105, and magnet supporting substrates 111a and 111b. Further, the lens holder 102 includes an objective lens 106, connecting parts 107a and 107b, a focus coil 108, and a tracking coil 109.

The lens holder 102 can be driven in a focus direction and in a tracking direction. The lens holder 102 is driven in a focus direction by causing a current to flow through the focus coil 108 of a focus-direction magnetic circuit constituted by (i) the focus coil 108 provided in the lens holder 102, (ii) the magnet supporting substrate 111a provided perpendicularly with respect to the substrate 104, and (iii) a magnet 110a supported by the magnet supporting substrate 111a.

Further, the lens holder 102 is driven in a tracking direction by causing a current to flow through the tracking coil 109 of a tracking-direction magnetic circuit constituted by (a) the tracking coil 109 provided in the lens holder 102, (b) the magnet supporting substrate 111b provided perpendicularly with respect to the substrate 104, and (c) a magnet 110b supported by the magnet supporting substrate 111b.

The substrate 104 takes the form of a rectangular plate, and the wire supporting base 105, which has a cuboidal shape, is provided perpendicularly along one of the shorter sides of the substrate 104. Further, the magnet supporting substrates 111a and 111b, each of which has a cuboidal shape, are provided perpendicularly with respect to the same surface of the substrate 104 as the wire supporting base 105 is provided.

The lens holder 102 is integrally constituted by a cuboidal section and a lens holding section. The cuboidal section includes the focus-direction magnetic circuit and the tracking-direction magnetic circuit. The lens holding section is provided along one of the shorter sides of the cuboidal section, and holds the objective lens 106. The supporting wires 103a, 103b, 103c, and 103d, each of which has elasticity, connect the lens holder 102 to the wire supporting base 105 so that a lower surface of the lens holder 102 is parallel to an upper surface of the substrate 104.

Moreover, the supporting wires 103a and 103b are provided perpendicularly with respect to a focus direction, and are arranged in a focus direction. The supporting wires 103a and 103b extend in a longitudinal direction of the lens holder 102, and are connected to the connecting part 107a, which is provided in a longitudinal direction on a side surface of the lens holder 102. Similarly, the supporting wires 103c and 103d are provided perpendicularly with respect to a focus direction, and are arranged in a focus direction. The supporting wires 103c and 103d extend in the longitudinal direction of the lens holder 102, and are connected to the connecting part 107b, which is provided in a longitudinal direction on a side surface opposite to the surface of the lens holder 102 on which surface the connecting part 107a is provided. Further, the supporting wires 103a and 103c are provided in parallel with each other, and the supporting wires 103b and 103d are provided in parallel with each other.

Thus, in the conventional objective lens driving device 101, the supporting wires 103a, 103b, 103c, and 103d connect the lens holder 102 to the wire supporting base 105 so that the lens holder 102 is freely movable in a focus direction and in a tracking direction.

Further, Japanese Unexamined Patent Publication No. 77153/2003 (Tokukai 2003-77153; published on Mar. 14, 2003) discloses an objective lens driving device arranged so that the supporting wires 103a and 103c intersect each other and that the supporting wires 103b and 103d intersect each other.

In order to accurately carrying out recording or reproduction of information with respect to an optical information recording medium by using an objective lens driving device, it is preferable that an optical axis of an objective lens be always perpendicular to a recording surface of the optical information recording medium.

However, the aforementioned conventional arrangement cause a problem that: when the focus-direction magnetic circuit drives the lens holder 102 in a focus direction, the supporting wires 103a, 103b, 103c, and 103d are deformed, with the result that a tangential tilt of the lens holder 102 is caused.

The cause of the aforementioned problem will be described below with reference to FIG. 10. FIG. 10 is a side view showing stress exerted on the conventional objective lens driving device 101. In FIG. 10, the magnet supporting substrates 111a and 111b provided on the substrate 104 are omitted for simplicity. In cases where the lens holder 102 driven by the focus-direction magnetic circuit is moved, for example, toward a higher position, the supporting wires 103a, 103b, 103c, and 103d will be bent in accordance with the movement of the lens holder 102.

However, each of the supporting wires 103a, 103b, 103c, and 103d has (i) one end connected to the wire supporting base 105 and (ii) the other end connected to the connecting part 107a or the connecting part 107b. Therefore, as indicated by the arrows in FIG. 10, compressive stress is exerted on the supporting wires 103a and 103c, and tensile stress is exerted on the supporting wires 103b and 103d.

Then, the supporting wires 103a, 103b, 103c, and 103d are unevenly deformed in order to correct the stress imbalance thus exerted. Therefore, a tangential tilt of the lens holder 102 is caused.

### SUMMARY OF THE INVENTION

The present invention has been made in view of the foregoing problems, and it is an object of the present invention to provide an objective lens driving device in which a lens holder is restrained from tilting when the lens holder is moved in the direction of the optical axis of an objective lens.

In order to solve the foregoing problems, an objective lens driving device of the present invention is an objective lens driving device, including: a lens holder, which holds an objective lens that converges light of a light source on a recording surface of an optical information recording medium so that information is recorded or reproduced; a bar-like elastic member, which connects the lens holder to a supporting substrate; and driving means, which changes a position of the lens holder relative to the supporting substrate by applying force to the lens holder in either of directions of an optical axis of the objective lens in order to cause the elastic member to be elastically deformed in a bending direction, the elastic member having at least one bent portion extending in different axial directions, the elastic member being included in a flat surface parallel to a flat surface including the optical axis of the objective lens.

In a conventional case where an elastic member is constituted by linear wires or other members, compressive stress and tensile stress are exerted on the elastic member by moving the lens holder in either of the directions of the optical axis of the object lens. This causes the elastic member to be deformed. Therefore, in the conventional objective lens driving device, the lens holder tilts in the direction in which the lens holder rotates with respect to the optical axis of the objective lens.

According to the present embodiment, the elastic member has at least one bent portion extending in different axial directions and is included in the flat surface parallel to the flat surface including the optical axis of the objective lens. Therefore, when the lens holder 2 is moved in a direction of the optical axis of the objective lens, compressive stress and tensile stress are exerted on the elastic member, and are converted into bending stress at the bent portion. Accordingly, the angle of the bent portion of the elastic member is changed.

Thus, in the objective lens driving device of the present invention, the elastic member is bent at least one portion so as to be included in the flat surface parallel to the flat surface including the optical axis of the objective lens. With this, the compressive stress and the tensile stress each exerted on the elastic member are concentrated at the bent portion, and are converted into bending stress. Therefore, the angle of the bent portion is changed, so that the elastic member can be prevented from being unevenly bent at a portion other than the bent portion. As a result, the lens holder can be prevented from tilting in the direction in which the lens holder rotates with respect to the direction of the optical axis of the objective lens.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a perspective view showing an embodiment of an objective lens driving device according to the present invention.

FIG. 2 is a side view showing the objective lens driving device.

FIG. 3 is a side view showing stress exerted on the objective lens driving device.

FIG. 4 is a side view showing another embodiment of the objective lens driving device according to the present invention.

FIG. 5(a) is a plan view showing a relationship between (i) connecting locations at which supporting wires are connected to connecting parts and (ii) the center of gravity of a lens holder.

FIG. 5(b) is a cross-sectional view showing a cross-sectional surface taken along the line A-A′ of FIG. 5(a) and seen from the direction of arrows.

FIG. 6(a) is a plan view illustrating that there is no appropriate positional relationship between (i) the connecting locations at which the supporting wires are connected to the connecting parts and (ii) the center of gravity of the lens holder.

FIG. 6(b) is a cross-sectional view showing a cross-sectional surface taken along the line A-A′ of FIG. 6(a) and seen from the direction of arrows.

FIG. 7(a) is a plan view showing a relationship between (i) the connecting locations at which the supporting wires are connected to the connecting parts and (ii) the center of drive of a focus-direction magnetic circuit of the lens holder.

FIG. 7(b) is a cross-sectional view showing a cross-sectional surface taken along the line A-A′ of FIG. 7(a) and seen from the direction of arrows.

FIG. 8(a) is a plan view illustrating that there is no appropriate positional relationship between (i) the connecting locations at which the supporting wires are connected to the connecting parts and (ii) the center of drive of the focus-direction magnetic circuit of the lens holder.

FIG. 8(b) is a cross-sectional view showing a cross-sectional surface taken along the line A-A′ of FIG. 8(a) and seen from the direction of arrows.

FIG. 9 is a perspective view showing a conventional objective lens driving device.

FIG. 10 is a side view showing stress exerted on the conventional objective lens driving device.

### DESCRIPTION OF THE EMBODIMENTS

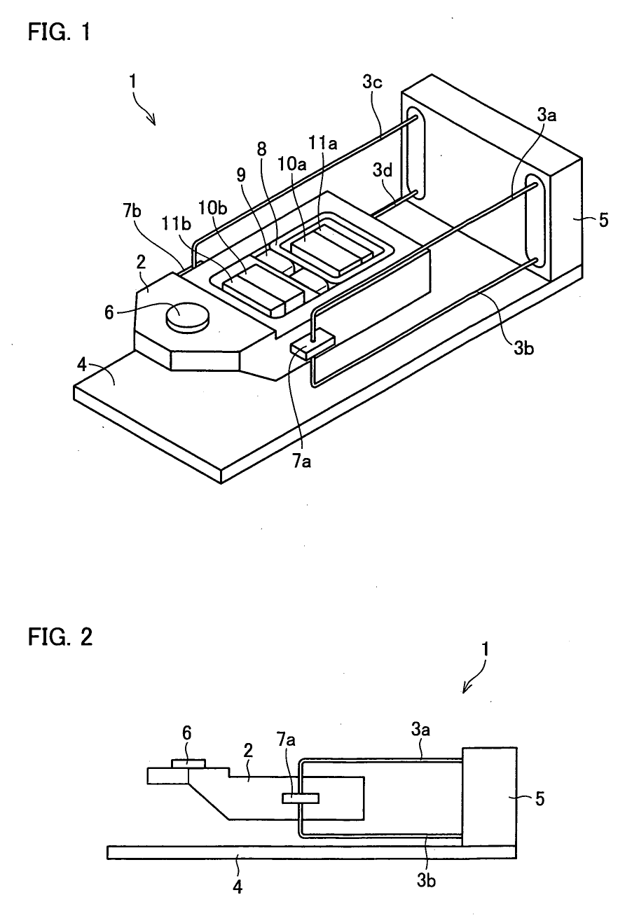

Embodiments of the present invention will be described below with reference to FIGS. 1 through 8.

An objective lens driving device of the present embodiment causes an objective lens to converge light of a light source as a light spot on a recording surface of an optical information recording medium, and causes the objective lens to move in focus directions and in tracking directions so as to carry out focusing and positioning of the light spot.

The wording “focus directions” refers to directions of an optical axis of an objective lens. The wording “tracking directions” refers to radial directions of a disk-like optical information recording medium. Further, the optical information recoding medium refers to such a recording medium that information can be recorded or reproduced by converging light on a recording surface of the recording medium. Examples of the optical information recording medium include an optical disk, a magnetooptic disk, and the like.

### Embodiment 1

An arrangement of an objective lens driving device 1 according to Embodiment 1 of the present invention will be described with reference to FIGS. 1 and 2. FIG. 1 is a perspective view showing the arrangement of the objective lens driving device 1 of the present embodiment. Further, FIG. 2 is a side view showing the arrangement of the objective lens driving device 1 of the present embodiment.

The objective lens driving device 1 of the present embodiment includes a lens holder 2, supporting wires (elastic members) 3a, 3b, 3c, and 3d, a substrate 4, a wire supporting base (supporting substrate) 5, and magnet supporting substrates 11a and 11b.

It is assumed in the present embodiment that the lens holder 2 is in its rest position when the lens holder 2 is not driven as shown in FIGS. 1 and 2.

The substrate 4 serves as a base of the objective lens driving device 1, and has a shape of a rectangular plate. The wire supporting base 5 supports the lens holder 2 with the use of the supporting wires 3a, 3b, 3c, and 3d. The wire supporting base 5 has a cuboidal shape, and is provided perpendicular to and on the substrate 4 such that one end of the wire supporting base 5 meets one of the shorter sides of the substrate 4. Further, the magnet supporting substrates 11a and 11b, each of which has a cuboidal shape, are provided perpendicular to and on the surface of the substrate 4 together with the wire supporting base 5.

The lens holder 2 holds an objective lens 6, and drives the objective lens 6 in a focus direction and in a tracking direction. The lens holder 2 includes the objective lens 6, connecting parts 7a and 7b, a focus coil 8, and a tracking coil 9. The lens holder 2 is driven in a focus direction by supplying a current to the focus coil 8 of a focus-direction magnetic circuit (driving means) constituted by (i) the focus coil 8 provided in the lens holder 2, (ii) the magnet supporting substrate 11a provided perpendicular to and on the substrate 4, and (iii) a magnet 10a supported by the magnet supporting substrate 11a.

In the meanwhile, the lens holder 2 is driven in a tracking direction by supplying a current to the tracking coil 9 of a tracking-direction magnetic circuit constituted by (a) the tracking coil 9 provided in the lens holder 2, (b) the magnet supporting substrate 11b provided perpendicular to and on the substrate 4, and (iii) a magnet 10b supported by the magnet supporting substrate 11b.

The lens holder 2 is integrally constituted by a cuboidal section and a lens holding section. The cuboidal section includes the focus-direction magnetic circuit and the tracking-direction magnetic circuit. The lens holding section is provided on one of the shorter sides of the cuboidal section, and includes the objective lens 6. Moreover, the connecting parts 7a and 7b to which the supporting wires 3a (3b) and 3c (3d) are connected are provided on both longitudinal side surfaces of the lens holder 2, respectively. Each of the connecting parts 7a and 7b has a rectangular plate shape, and is provided at such a position that a distance from the upper surface of the lens holder 2 is substantially the same as a distance from the lower surface thereof.

The supporting wires 3a, 3b, 3c, and 3d are elastic wires, and connect the lens holder 2 to the wire supporting base 105 so that the lower surface of the lens holder 2 is parallel to the upper surface of the substrate 4.

Each of the supporting wires 3a, 3b, 3c, and 3d has one end connected to the wire supporting base 5. Moreover, the supporting wires 3a and 3b extend in a direction perpendicular to the focus direction, and are arranged in parallel with each other along the focus direction. Specifically, the supporting wires 3a and 3b extend, in the longitudinal direction of the lens holder 2, from the wire supporting base 5 to locations that are away from the upper and lower surfaces of the connecting part 7a by a predetermined distance, respectively. Moreover, the supporting wires 3a and 3b are bent face to face with each other in the focus directions, and are connected to the upper and lower surfaces of the connecting part 7a, respectively.

Similarly, the supporting wires 3c and 3d extend in a direction perpendicular to the focus direction, and are arranged in parallel with each other along the focus direction. Specifically, the supporting wires 3c and 3d extend, in the longitudinal direction of the lens holder 2, from the wire supporting base 5 to locations that are away from the upper and lower surfaces of the connecting part 7b by a predetermined distance, respectively. Moreover, the supporting wires 3c and 3d are bent face to face with each other in the focus directions, and are connected to the upper and lower surfaces of the connecting part 7b, respectively.

In the present embodiment, elastic wires are used as the supporting wires 3a, 3b, 3c, and 3d. However, the present invention is not limited to this. That is, a supporting member for allowing the wire supporting base 5 to support the lens holder 2 only needs to be elastic, and may be a plate material or the like.

Note that concrete explanation will be given later for (i) where in the lens holder 2 the connecting parts 7a and 7b are mounted and (ii) where in the connecting parts 7a and 7b the supporting wires 3a (3b) and 3c (3d) are respectively connected.

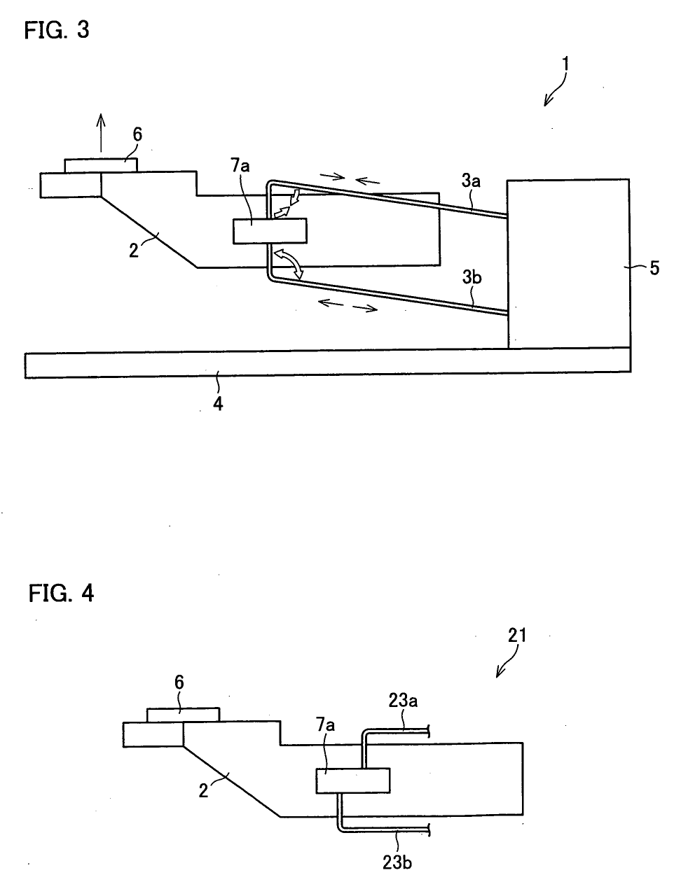

With reference to FIG. 3, the following describes an arrangement of the objective lens driving device 1 of the present embodiment, i.e., an arrangement in which a tangential tilt is restrained from being caused when the lens holder 2 is moved in a focus direction. Note that the tangential tilt refers to a tilt inclining in the direction in which the lens holder 2 rotates on a line connecting the connecting parts 7a and 7b.

FIG. 3 is a side view showing stress exerted on the objective lens driving device 1 of the present embodiment. The arrows in FIG. 3 indicate compressive stress exerted on the supporting wire 3a (3c) and tensile stress exerted on the supporting wire 3b (3d). Further, the white arrows in FIG. 3 indicate bending stress exerted on the bent portion of the supporting wire 3a (3c) and bending stress exerted on the bent portion of the supporting wire 3b (3d).

Conventionally, as described above, in cases where an elastic member is constituted by linear wires or other members, the elastic member is deformed by compressive stress and tensile stress caused by moving a lens holder in the focus directions. This results in a tangential tilt of the lens holder of the conventional objective lens driving device.

In light of this, in the present embodiment, the supporting wires 3a (3c) and 3b (3d) are bent face to face with each other in the focus directions respectively, so that compressive stress and tensile stress each caused by moving the lens holder 2 in a focus direction are converted into bending stress at the respective bent portions.

Specifically, for example, consider a case where the lens holder 2 is driven from its rest position in an upward focus direction (i.e., in such a direction that the lens holder 2 gets away from the substrate 4). In this case, as indicated by the arrows in FIG. 3, compressive stress is exerted on a portion of the supporting wire 3a (3c), i.e., a portion extending from (i) a portion connected to the wire supporting base 5 to (ii) the bent portion. As indicated by the white arrows in FIG. 3, the compressive stress thus exerted on the supporting wire 3a (3c) is converted into bending stress for reducing the angle of the bent portion of the supporting wire 3a (3c). Accordingly, the supporting wire 3a (3c) is deformed so that the bent portion of the supporting wire 3a (3c) has an angle smaller than the bent portion of the supporting wire 3a (3c) does when the lens holder 2 is in its rest position.

On the other hand, as indicated by the arrows in FIG. 3, tensile stress is exerted on a portion of the supporting wire 3b (3d), i.e., on a portion extending from (i) a portion connected to the wire supporting base 5 to (ii) the bent portion. As indicated by the white arrows in FIG. 3, the tensile stress exerted on the supporting wire 3b (3d) is converted into bending stress for increasing the angle of the bent portion of the supporting wire 3b (3d). Therefore, the supporting wire 3b (3d) is deformed so that the bent portion of the supporting wire 3b (3d) has an angle larger than the bent portion of the supporting wire 3b (3d) does when the lens holder 2 is in its rest position.

That is, in the case where, e.g., the lens holder 2 is driven from its rest position in the upward focus direction, the compressive stress is exerted on the supporting wire 3a (3c) and is converted into the bending stress for reducing the angle of the bent portion of the supporting wire 3a (3c), and the tensile stress is exerted on the supporting wire 3b (3d) and is converted into the bending stress for increasing the angle of the bent portion of the supporting wire 3b (3d). Therefore, in each of the supporting wires 3a, 3b, 3c, and 3d, the portion extending from (i) the portion connected to the wire supporting base 5 to (ii) the bent portion is restrained from being deformed, so that a tangential tilt of the lens holder 2 is restrained. As a result, the lens holder 2 can be moved in the focus direction with the lens holder kept horizontal.

It is preferable that each bent portion of the supporting wires 3a, 3b, 3c, and 3d have an angle of approximately 90°. When the bent portion has an acute angel of less than 90°, the compressive stress exerted on each of the supporting wires 3a, 3b, 3c, and 3d is easily absorbed in the bent portion. However, it is difficult that the tensile stress exerted on each of the supporting wires 3a, 3b, 3c, and 3d is absorbed in the bent portion. On the other hand, when each of the bent portions has an obtuse angle of more than 90°, the tensile stress exerted on each of the supporting wires 3a, 3b, 3c, and 3d is easily absorbed in the bent portion. However, it is difficult that the compressive stress exerted on each of the supporting wires 3a, 3b, 3c, and 3d is absorbed in the bent portion.

Each of the bent portions of the supporting wires 3a, 3b, 3c, and 3d is set to have an angle of approximately 90° as such, so that the compressive stress or tensile stress exerted on the supporting wires 3a, 3b, 3c, and 3d can be easily converted into bending stress at the respective bent portions. Therefore, the objective lens driving device 1 of the present embodiment makes it possible to stably move the lens holder 2 by equal distances from its rest position in both the upward and downward focus directions.

For example, in cases where different types of optical information recording media such as a DVD and a CD are handled by a single unit, a light spot for information recording or information reproducing is focused on one optical information recording medium when a lens holder is positioned at a certain height, whereas a light spot therefor is focused on another optical information recording medium when the lens holder is positioned at a different height. Therefore, in the objective lens driving device 1 of the present embodiment, the rest position of the lens holder 2 is located near a middle position between the heights of the lens holder 2, at which heights the light spots are focused respectively on the optical information recording media. This makes it possible to stabilize properties of recording or reproduction with respect to the optical information recording media.

In the present embodiment, each of the supporting wires 3a, 3b, 3c, and 3d has one bent portion. However, the present invention is not limited to this. That is, each of the supporting wires 3a, 3b, 3c, and 3d may have a plurality of portions that are bent in the focus directions. Further, each of the supporting wires 3a, 3b, 3c, and 3d may be bent in a direction other than the focus directions. However, by bending each of the supporting wires 3a, 3b, 3c, and 3d at one portion in a focus direction, the compressive stress and the tensile stress each exerted on the supporting wires 3a, 3b, 3c, and 3d can be converged in the respective bent portions and converted into bending stress. With this, each of the supporting wires 3a, 3b, 3c, and 3d, can be restrained from being bent at a portion other than the bent portion. This makes it possible to stably move the lens holder 2 in a focus direction.

### Embodiment 2

As described above, a light spot for information recording or information reproducing is focused on one optical information recording medium when a lens holder is positioned at a certain height, and a light spot therefor is focused on another optical information recording medium when the lens holder is positioned at a different height.

In the objective lens driving device 1 of Embodiment 1, the rest position of the lens holder 2 is a position most appropriate for focusing of a light spot. Therefore, in cases where there is a big difference between (i) the rest position of the lens holder 2 and (ii) a position to which the lens holder 2 is moved so that a light spot is focused on an optical information recording medium, it is difficult to stably move the lens holder 2.

However, an objective lens driving device 21 according to Embodiment 2 of the present invention allows stable focusing even when there is a big difference between (i) the rest position of the lens holder 2 and (ii) a height of the lens holder 2, at which height a light spot is focused on an optical information recording medium. The objective lens driving device 21 of the present embodiment will be described with reference to FIG. 4. FIG. 4 is a side view showing an arrangement of the objective lens driving device 21 of the present embodiment. Note that components having the same functions as those of the objective lens driving device 1 of Embodiment 1 are given the same reference numerals, respectively.

The following explains how the objective lens driving device 21 of the present embodiment is different from those of the objective lens driving device 1 of Embodiment 1. The objective lens driving device 21 is provided with supporting wires 23a, 23b, 23c, and 23d. The supporting wires 23a, 23b, 23c, and 23d connect the lens holder 2 to the wire supporting base 5 so that the lens holder 2 is parallel to the substrate 4. The supporting wires 23a, 23b, 23c, and 23d are disposed in the same manner as the supporting wires 3a, 3b, 3c, and 3d, respectively. Therefore, further explanation therefor will not be described.

The objective lens driving device 21 is arranged so that the length of the supporting wire 23a from the wire supporting base 5 to a bent portion of the supporting wire 23a is shorter than the length of the supporting wire 23b from the wire supporting base 5 to a bent portion of the supporting wire 23b. Similarly, the objective lens driving device 21 is arranged so that the length of the supporting wire 23c from the wire supporting base 5 to an upper part of the connection part 7b is shorter than of the length of the supporting wire 23d from the wire supporting base 5 to a lower part of the connecting part 7b.

With this, the ratio between (i) the length of the supporting wire 23a (23c) from the wire supporting base 5 to the bent portion of the supporting wire 23a (23c) and (ii) the length of the supporting wire 23a (23c) from the bent portion of the supporting wire 23a (23c) to the upper part of the connecting part 7a (7b) is smaller than the ratio between (a) the length of the supporting wire 23b (23d) from the wire supporting base 5 to the bent portion of the supporting wire 23b (23d) and (ii) the length of the supporting wire 23b (23d) from the bent portion of the supporting wire 23b (23d) to the lower part of the connecting part 7a (7b). Accordingly, the lens holder 2 can be stably moved to a position lower than the rest position of the lens holder 2. Therefore, the objective lens driving device 21 is used suitably for an optical information recording medium on which a light spot is focused when the lens holder 2 is in a position lower than the rest position of the lens holder 2.

On the other hand, the objective lens driving device 21 may be arranged so that the length of the supporting wire 23a (23c) from the wire supporting base 5 to the bent portion of the supporting wire 23a (23c) is longer the length of the supporting wire 23b (23d) from the wire supporting base 5 to the bent portion of the supporting wire 23b (23d). In this case, the objective lens driving device 21 is used suitably for an optical information recording medium on which a light spot is focused when the lens holder 2 is in a position higher than the rest position of the lens holder 2.

[Connecting Locations of the Supporting Wires]

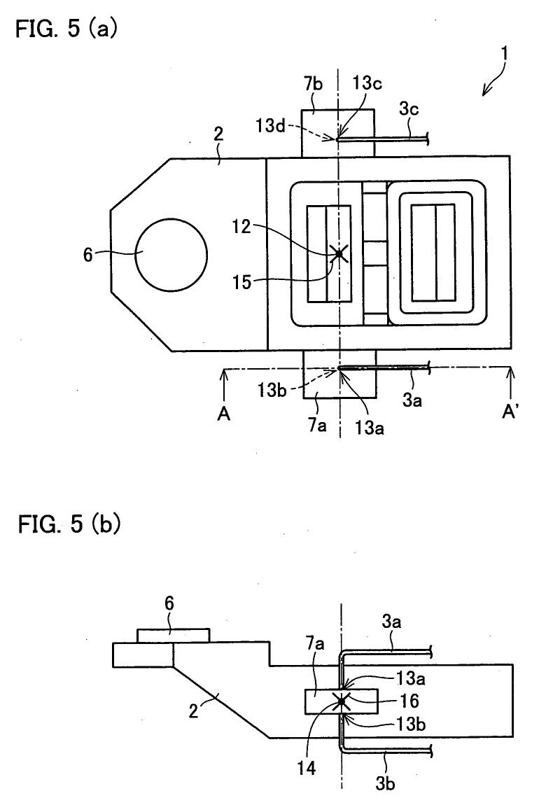

Described below with reference to FIG. 5 through FIG. 8 are (i) where in both the longitudinal side surfaces of the lens holder 2 the connecting parts 7a and 7b are respectively mounted, (ii) where in the connecting parts 7a and 7b the supporting wires 3a (3b) and 3c (3d) of Embodiment 1 are respectively connected, and (iii) where in the connecting parts 7a and 7b the supporting wires 23a (23b) and 23c (23d) of Embodiment 2 are respectively connected. The following description is with regards to the supporting wires 3a, 3b, 3c, and 3d of Embodiment 1, but the same is true of the supporting wires 23a, 23b, 23c, and 23d.

As described above, the supporting wire 3a (3c) and the supporting wire 3b (3d) are bent face to face with each other in the focus directions respectively, so that the compressive stress and the tensile stress caused by moving the lens holder 2 in the focus directions are converted into bending stress at the respective bent portions. For the purpose of efficiently converting, into bending stress, the compressive stress and the tensile stress each exerted on the supporting wires 3a, 3b, 3c, and 3d, it is preferable that no unnecessary moment be generated in the lens holder 2. For that purpose, it is necessary to consider where in the connecting parts 7a and 7b the supporting wires 3a (3b) and 3c (3d) should be connected.

The supporting wires 3a (3b) and 3c (3d) may be respectively connected, in consideration of the center of gravity of the lens holder 2, to such connecting locations of the connecting parts 7a and 7b that no unnecessary moment is generated in the lens holder 2. Alternatively, the supporting wires 3a (3b) and 3c (3d) may be respectively connected, in consideration of the center of drive of the focus-direction magnetic circuit of the lens holder 2, to such connecting locations of the connecting parts 7a and 7b that no unnecessary moment is generated in the lens holder 2.

Firstly explained is the arrangement in which the supporting wires 3a (3b) and 3c (3d) are respectively connected to the connecting parts 7a and 7b in consideration of the center of gravity of the lens holder 2. The explanation is made with reference to FIGS. 5(a) and 5(b).

The supporting wire 3a is connected to the upper surface of the connecting part 7a at a connection point 13a (first connection point), and the supporting wire 3c is connected to the upper surface of the connecting part 7b at a connection point 13c (first connection point). The supporting wire 3b is connected to the lower surface of the connecting part 7a at a connection point 13b (second connection point), and the supporting wire 13d is connected to the lower surface of the connecting part 7b at a connection point 13d (second connection point).

FIG. 5(a) is a plan view showing a relationship between (i) the connecting locations at which the supporting wire 3a (3b) and the supporting wires 3c (3d) are respectively connected to the connecting parts 7a and 7b and (ii) the center of gravity 12 of the lens holder 2. FIG. 5(b) is a cross-sectional view taken along the line A-A′ of FIG. 5(a) and seen from the direction of arrows. A point 12 in FIG. 5(a) indicates the center of gravity of the lens holder 2, and a point 14 in FIG. 5(b) indicates a point positioned in the cross sectional surface taken along the line A-A′ and corresponding to the center of gravity of the lens holder 2. Further, an “x” mark 15 in FIG. 5(a) indicates a middle point located halfway between the connection points 13a and 13c, and an “x” mark 16 in FIG. 5(b) indicates a middle point located halfway between the connection points 13a and 13b.

The following describes an example in which the lens holder 2 that is in its rest position is subjected to unnecessary moment because of the positional relationship between (i) the connecting locations at which the supporting wires 3a (3b) and 3c (3d) are respectively connected to the connecting parts 7a and 7b and (ii) the center of gravity 12 of the lens holder 2.

For example, a tangential tilt of the lens holder 2 that is in its rest position is caused when there is no balance of moment among (i) the force by which the supporting wires 3a and 3c support the lens holder 2 at the connection points 13a and 13c respectively, (ii) the force by which the supporting wires 3b and 3d support the lens holder 2 at the connection points 13b and 13d respectively, and (iii) the gravity exerted on the center of gravity 12 of the lens holder 2.

Further, for example, a radial tilt of the lens holder 2 that is in its rest position is caused when there is no balance of moment among (i) the force by which the supporting wires 3a and 3b support the lens holder 2 at the connection points 13a and 13b, (ii) the force by which the supporting wires 3c and 3d support the lens holder 2 at the connection points 13c and 13d respectively, and (iii) the gravity exerted on the center of gravity 12 of the lens holder 2. In the present embodiment, the radial tilt refers to a tilt inclining in the direction in which the lens holder 2 rotates on a line perpendicular to the optical axis of the objective lens 6 and parallel to the longitudinal direction of the lens holder 2.

Thus, when unnecessary moment is exerted on the lens holder 2 that is in its rest position, a tilt of the lens holder 2 is caused. The tilt of the lens holder 2 makes it difficult that: when the lens holder 2 is moved in a focus direction, compressive stress and tensile stress are exerted on the supporting wires 3a, 3b, 3d, 3d, and are converted into bending stress at the respective bent portions.

In view of this, the supporting wires 3a, 3b, 3c, and 3d are respectively connected to the upper surface of the connecting part 7a, the lower surface of the connecting part 7a, the upper surface of the connecting part 7b, and the lower surface of the connecting part 7b so that the center of gravity 12 of the lens holder 2 falls on a line connecting (i) the middle point 16 between the connection points 13a and 13b with (ii) a middle point (not shown) between the connection points 13c and 13d and that the center of gravity 12 of the lens holder 2 falls on a line connecting (a) the middle point 15 between the connection points 13a and 13c with (b) a middle point (not shown) between the connection points 13b and 13d.

The above arrangement will be specifically described with reference to FIGS. 5(a) and 5(b).

As shown in FIG. 5(a) in which the lens holder 2 is seen from an upper surface thereof, the connecting parts 7a and 7b are respectively provided on the longitudinal side surfaces of the lens holder 2 so as to be symmetric with respect to the center of gravity 12 of the lens holder 2.

Further, as shown in FIG. 5(b) in which the lens holder 2 is seen from the side surface thereof on which the connecting part 7a is provided, the connecting parts 7a and 7b are respectively provided on the longitudinal side surfaces of the lens holder 2 so as to cover the point 14 positioned in the cross sectional surface taken along the line A-A′ and corresponding to the center of gravity 12 of the lens holder 2.

As shown in FIG. 5(a) in which the lens holder 2 is seen from the upper surface thereof, the supporting wires 3a and 3c are respectively connected to the upper surfaces of the connecting parts 7a and 7b so that the middle point 15 between the connection points 13a and 13c corresponds to the center of gravity 12 of the lens holder 2. Further, the supporting wires 3b and 3d are respectively connected to the lower surfaces of the connecting parts 7a and 7b in the same manner.

Further, as shown in FIG. 5(b) in which the lens holder 2 is seen from the side surface thereof on which the connecting part 7a is provided, the supporting wires 3a and 3b are respectively connected to the upper and lower surfaces of the connecting part 7a so that the middle point 16 between the connection points 13a and 13b corresponds to the point 14 positioned in the cross sectional surface taken along the line A-A′ and corresponding to the center of gravity 12 of the lens holder 2. Further, in a case (not shown) where the lens holder 2 is seen from the side surface thereof on which the connecting part 7b is provided, the supporting wires 3c and 3d are respectively connected to the upper and lower surfaces of the connecting part 7b in the same manner.

With the above arrangement, a balance of moment is kept among (i) the force by which the supporting wires 3a and 3b support the lens holder 2 at the connection points 13a and 13b respectively, (ii) the force by which the supporting wires 3c and 3d support the lens holder 2 at the connection points 13c and 13d respectively, and (iii) the gravity exerted on the center of gravity 12 of the lens holder 2.

Further, a balance of moment is kept among (i) the force by which the supporting wires 3a and 3c support the lens holder 2 at the connection points 13a and 13c respectively, (ii) the force by which the supporting wires 3b and 3d support the lens holder 2 at the connection points 13b and 13d respectively, and (iii) the gravity exerted on the center of gravity 12 of the lens holder 2.

Therefore, no unnecessary moment is exerted on the lens holder 2, so that the lens holder 2 can be restrained from having a radial tilt and a tangential tilt.

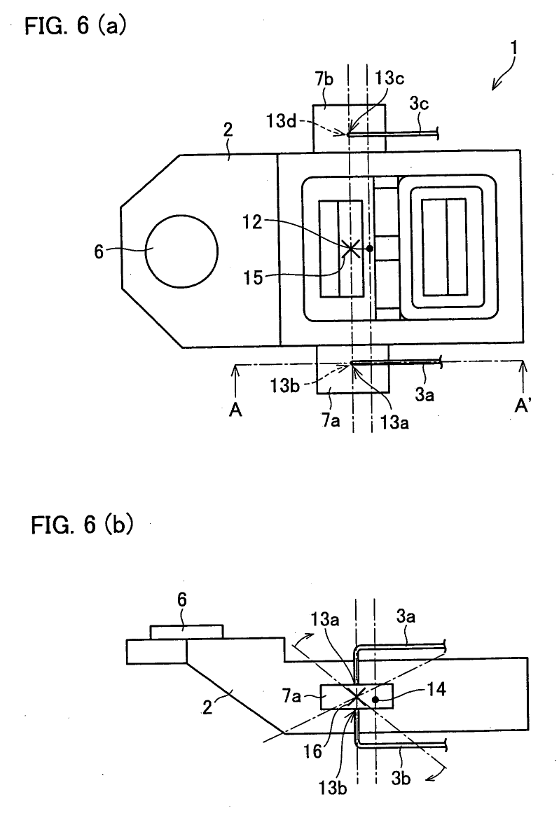

With reference to FIG. 6, the following describes moment exerted on the lens holder 2 when there is no appropriate positional relationship among (i) the connecting locations at which the supporting wires 3a and 3b are connected to the connecting part 7a, (ii) the connecting locations at which the supporting wires 3c and 3d are connected to the connecting part 7b, and (iii) the center of gravity of the lens holder 2.

FIG. 6(a) is a plan view illustrating that there is no appropriate positional relationship among (i) the connecting locations at which the supporting wires 3a and 3b are connected to the connecting part 7a, (ii) the connecting locations at which the supporting wires 3c and 3d are connected to the connecting part 7b, and (iii) the center of gravity of the lens holder 2. FIG. 6(b) is a cross-sectional view taken along the line A-A′ of FIG. 6(a) and seen from the direction of arrows. The arrows in FIG. 6(b) indicate moment exerted on the lens holder 2.

As shown in FIG. 6(a) in which the lens holder 2 is seen from the upper surface thereof, the supporting wires 3a, 3b, 3c, and 3d are respectively connected to the upper surface of the connecting part 7a, the lower surface of the connection part 7a, the upper surface of the connecting part 7b, and the lower surface of the connecting part 7b so that the middle point 15 between the connection points 13a and 13c and the middle point (not shown) between the connection points 13b and 13d do not correspond to the center of gravity 12 of the lens holder 2.

Further, as shown in FIG. 6(b) in which the lens holder 2 is seen from the side surface thereof on which the connecting part 7a is provided, the supporting wires 3a and 3b are respectively connected to the upper and lower surfaces of the connecting part 7a so that the middle point 16 between the connection points 13a and 13b does not correspond to the point 14 positioned in the cross sectional surface taken along the line A-A′ and corresponding to the center of gravity 12 of the lens holder 2.

Further, in a case (not shown) where the lens holder 2 is seen from the side surface thereof on which the connecting part 7b is provided, the supporting wires 3c and 3d are respectively connected to the upper and lower surfaces of the connecting part 7b in the same manner.

Accordingly, there is no balance of moment among (i) the force by which the supporting wires 3a and 3c support the lens holder 2 at the connection points 13a and 13c respectively, (ii) the force by which the supporting wires 3b and 3d support the lens holder 2 at the connection points 13b and 13d respectively, and (iii) the gravity exerted on the center of gravity 12 of the lens holder 2.

Moreover, as indicated by the arrows in FIG. 6(b), the lens holder 2 is subjected to such moment that the lens holder 2 rotates in the upward focus direction. Therefore, a tangential tilt of the lens holder 2 that is in its rest position is caused.

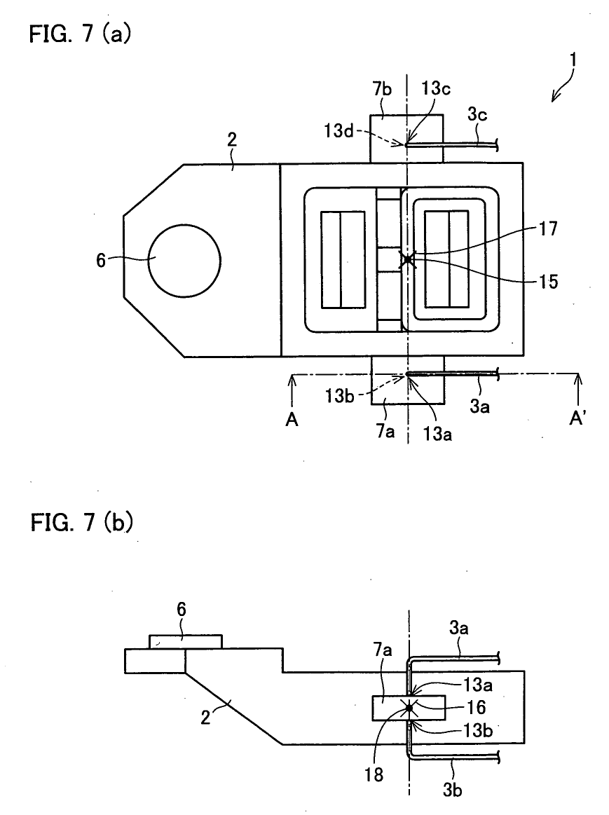

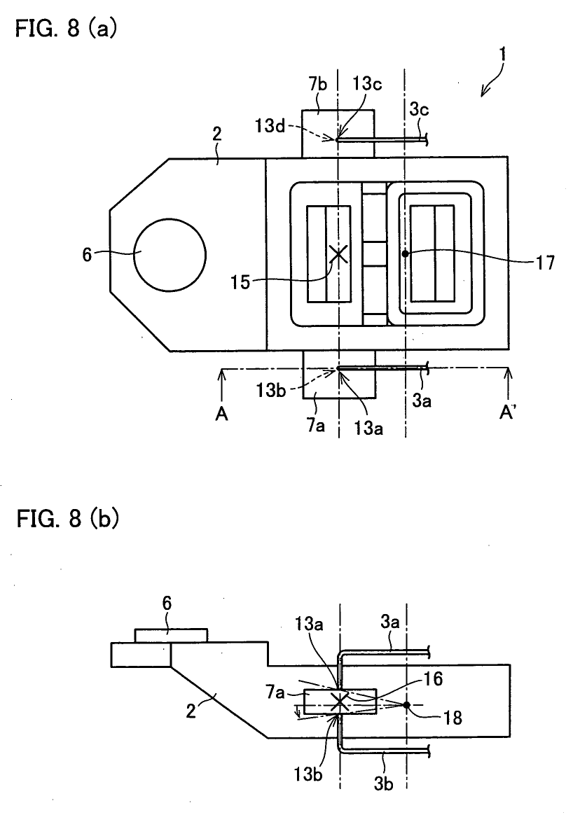

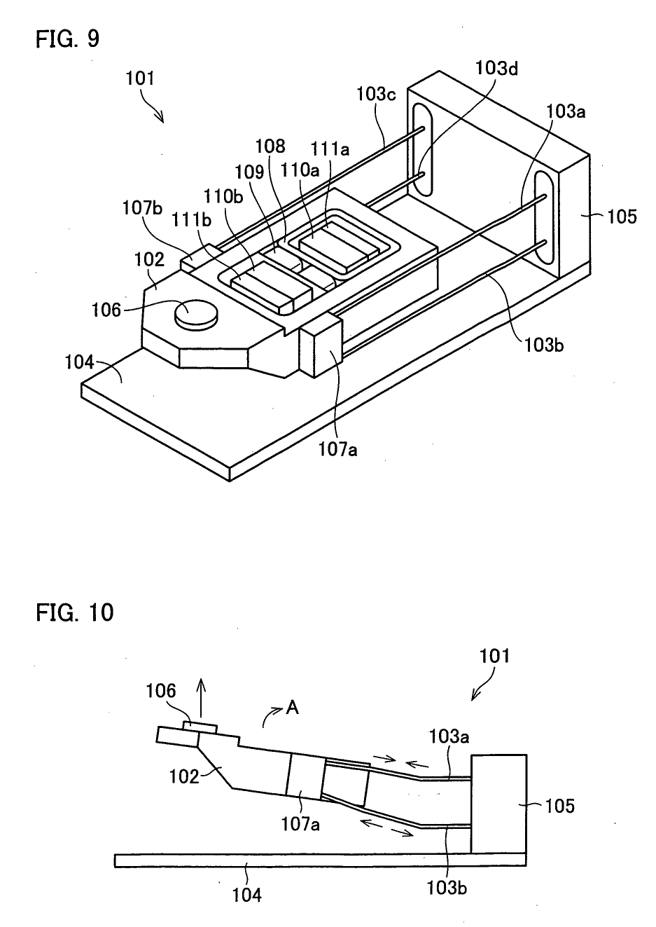

With reference to FIG. 7 through FIG. 8, the following describes the arrangement in which the supporting wires 3a (3b) and 3c (3d) are respectively connected to the connecting locations in the connecting parts 7a and 7b in consideration of the center of drive of the focus-direction magnetic circuit of the lens holder 2.

FIG. 7(a) is a plan view showing a relationship among (i) the connecting locations at which the supporting wires 3a and 3b are connected to the connecting part 7a, (ii) the connecting locations at which the supporting wires 3c and 3d are connected to the connecting part 7b, and (iii) the center of drive of the focus-direction magnetic circuit of the lens holder 2. FIG. 7(b) is a cross-sectional view taken along the line A-A′ of FIG. 7(a) and seen from the direction of arrows. Reference numeral 17 indicates the center of drive of the focus-direction magnetic circuit, and reference numeral 18 indicates a point positioned in the cross sectional surface taken along the line A-A′ and corresponding to the center of drive of the focus-direction magnetic circuit.

The following describes an example in which unnecessary moment is generated in the lens holder 2 due to the positional relationship among (i) the connecting locations at which the supporting wires 3a and 3b are connected to the connecting part 7a, (ii) the connecting locations at which the supporting wires 3c and 3d are connected to the connecting part 7b, and (iii) the center of drive 17 of the focus-direction magnetic circuit of the lens holder 2. The center of drive 17 of the focus-direction magnetic circuit refers to a point which is located in the focus-direction magnetic circuit of the lens holder 2 and on which the driving force is exerted to cause the lens holder 2 to move in a focus direction.

For example, consider a case where there is no balance of moment among (i) the force by which the supporting wires 3a and 3c support the lens holder 2 at the connection points 13a and 13c respectively, (ii) the force by which the supporting wires 3b and 3d support the lens holder 2 at the connection points 13b and 13d, and (iii) the driving force exerted on the center of drive 17 of the focus-direction magnetic circuit when the lens holder 2 is moved in a focus direction. In this case, a tangential tilt of the lens holder 2 is caused when the lens holder 2 is moved in the focus direction.

Further, for example, consider a case where there is no balance of moment among (i) the force by which the supporting wires 3a and 3b support the lens holder 2 at the connection points 13a and 13b respectively, (ii) the force by which the supporting wires 3c and 3d support the lens holder 2 at the connection points 13c and 13d, and (iii) the driving force exerted on the center of drive 17 of the focus-direction magnetic circuit when the lens holder 2 is moved in a focus direction. In this case, a radial tilt of the lens holder 2 is caused when the lens holder 2 is moved in the focus direction. In the present embodiment, the radial tilt refers to a tilt inclining in the direction in which the lens holder 2 rotates on a line perpendicular to the optical axis of the objective lens 6 and parallel to the longitudinal direction of the lens holder 2.

Thus, when unnecessary moment is exerted on the lens holder 2 being moved in a focus direction, a tilt of the lens holder 2 is caused. The tilt of the lens holder 2 makes it difficult that: when the lens holder 2 is moved in the focus direction, compressive stress and tensile stress is exerted on the supporting wires 3a, 3b, 3c, and 3d, and are converted into bending stress at the respective bent portions.

Therefore, the supporting wires 3a, 3b, 3c, and 3d are respectively connected to the upper surface of the connecting part 7a, the lower surface of the connecting part 7a, the upper part of the connecting part 7b, and the lower surface of the connecting part 7b so that the center of drive 17 of the focus-direction magnetic circuit of the lens holder 2 falls on a line connecting (i) the middle point 16 between the connection points 13a and 13b with (ii) the middle point (not shown) between the connection points 13c and 13d and that the center of drive 17 of the focus-direction magnetic circuit of the lens holder 2 falls on a line connecting (a) the middle point 15 between the connection points 13a and 13c with (b) the middle point (not shown) between the connection points 13b and 13d.

The above arrangement will be specifically described with reference to FIGS. 7(a) and 7(b).

As shown in FIG. 7(a) in which the lens holder 2 is seen from the upper surface thereof, the connecting parts 7a and 7b are respectively provided on the longitudinal side surfaces of the lens holder 2 so as to be symmetric with respect to the center of drive of the focus-direction magnetic circuit of the lens holder 2. Further, as shown in FIG. 7(b) in which the lens holder 2 is seen from the side surface thereof on which the connecting part 7a is provided, the connecting parts 7a and 7b are respectively provided on the longitudinal side surfaces of the lens holder 2 so as to cover the point 18 positioned in the cross-sectional surface taken along the line A-A′ and corresponding to the center of drive 17 of the focus-direction magnetic circuit.

As shown in FIG. 7(a) in which the lens holder 2 is seen from the upper surface thereof, the supporting wires 3a and 3c are respectively connected to the upper surfaces of the connecting parts 7a and 7b so that the middle point 15 between the connection points 13a and 13c corresponds to the center of drive 17 of the focus-direction magnetic circuit of the lens holder 2. Further, the supporting wires 3b and 3d are respectively connected to the lower surfaces of the connecting parts 7a and 7b in the same manner.

Further, as shown in FIG. 7 (b) in which the lens holder 2 is seen from the side surface thereof on which the connecting part 7a is provided, the supporting wires 3a and 3b are respectively connected to the upper and lower surfaces of the connecting part 7a so that the middle point 16 between the connection points 13a and 13b corresponds to the point 18 positioned in the cross-sectional surface taken along the line A-A′ and corresponding to the center of drive 17 of the focus-direction magnetic circuit. Further, in a case (not shown) where the lens holder 2 is seen from the side surface thereof on which the connecting part 7b is provided, the supporting wires 3c and 3d are respectively connected to the upper and lower surfaces of the connecting part 7b in the same manner.

With the above arrangement, a balance of moment is kept among (i) the force by which the supporting wires 3a and 3b support the lens holder 2 at the connection points 13a and 13b respectively, (ii) the force by which the supporting wires 3c and 3d support the lens holder 2 at the connection points 13c and 13d, and (iii) the driving force exerted on the center of drive 17 when the lens holder 2 is moved in a focus direction by the focus-direction magnetic circuit. Further, a balance of moment is kept among (a) the force by which the supporting wires 3a and 3c support the lens holder 2 at the connection points 13a and 13c respectively, (b) the force by which the supporting wires 3b and 3d support the lens holder 2 at the connection points 13b and 13d respectively, and (c) the driving force exerted on the center of drive 17 when the lens holder 2 is moved in the focus direction by the focus-direction magnetic circuit.

Therefore, no unnecessary moment is exerted on the lens holder 2, so that the lens holder 2 can be restrained from having a radial tilt and a tangential tilt.

Further, FIG. 8(a) is a plan view illustrating that there is no appropriate positional relationship among (i) the connecting locations at which the supporting wires 3a and 3b are connected to the connecting part 7a, (ii) the connecting locations at which the supporting wires 3c and 3d are connected to the connecting part 7b, and (iii) the center of drive 17 of the lens holder 2. FIG. 8(b) is a cross-sectional view taken along the line A-A′ of FIG. 8(a) and seen from the direction of arrows. The arrows in FIG. 8(b) indicate moment exerted on the lens holder 2.

As shown in FIG. 8(a) in which the lens holder 2 is seen from the upper surface thereof, the supporting wires 3a, 3b, 3c, and 3d are respectively connected to the upper surface of the connecting part 7a, the lower surface of the connecting part 7a, the upper surface of the connecting part 7b, and the lower surface of the connecting part 7b so that the middle point 15 between the connection points 13a and 13c and the middle point (not shown) between the connection points 13b and 13d do not correspond to the center of drive 17 of the focus-direction magnetic circuit of the lens holder 2. Further, as shown in FIG. 8(b) in which the lens holder 2 is seen from the side surface thereof on which the connecting part 7a is provided, the supporting wires 3a and 3b are respectively connected to the upper and lower surfaces of the connecting part 7a so that the middle point 16 between the connection points 13a and 13b does not correspond to a point 18 positioned in the cross sectional surface taken along the line A-A′ and corresponding to the center of drive 17 of the focus-direction magnetic circuit. Further, in a case (not shown) where the lens holder 2 is seen from a side surface thereof on which the connecting part 7b is provided, the supporting wires 3c and 3d are respectively connected to the upper and lower surfaces of the connecting part 7b in the same manner.

Accordingly, there is no balance of moment among (i) the force by which the supporting wires 3a and 3c support the lens holder 2 at the connection points 13a and 13c respectively, (ii) the force by which the supporting wires 3b and 3d support the lens holder 2 at the connection points 13b and 13d respectively, and (iii) the driving force exerted on the center of drive 17 when the lens holder 2 is moved in a focus direction by the focus-direction magnetic circuit. Moreover, as indicated by the arrows in FIG. 8(b), the lens holder 2 is subjected to such moment that the lens holder 2 rotates in the downward focus direction. This results in a tangential tilt of the lens holder 2 that is in its rest position.

In the present embodiment, the supporting wires 3a, 3b, 3c, and 3d are respectively connected to the upper surface of the connecting part 7a, the lower surface of the connecting part 7a, the upper surface of the connecting part 7b, and the lower surface of the connecting part 7b so that the center of gravity 12 of the lens holder 2 or the center of drive 17 of the focus-direction magnetic circuit of the lens holder 2 falls on a line connecting (i) the middle point 16 between the connection points 13a and 13b with (ii) the middle point (not shown) between the connection points 13c and 13d and that the center of gravity 12 of the lens holder 2 or the center of drive 17 of the focus-direction magnetic circuit of the lens holder 2 falls on a line connecting (a) the middle point 15 between the connection points 13a and 13c with (b) the middle point (not shown) between the connection points 13b and 13d. However, the present invention is not limited to this.

That is, the supporting wires 3a, 3b, 3c, and 3d may be only arranged so as to be respectively connected to the upper surface of the connecting part 7a, the lower surface of the connecting part 7a, the upper surface of the connecting part 7b, and the lower surface of the connecting part 7b so that the center of gravity 12 of the lens holder 2 or the center of drive 17 of the focus-direction magnetic circuit of the lens holder 2 falls on a line connecting (i) the middle point 16 between the connection points 13a and 13b with (ii) the middle point (not shown) between the connection points 13c and 13d. Alternatively, the supporting wires 3a, 3b, 3c, and 3d may be only arranged so as to be respectively connected to the upper surface of the connecting part 7a, the lower surface of the connecting part 7a, the upper surface of the connecting part 7b, and the lower surface of the connecting part 7b so that the center of gravity 12 of the lens holder 2 or the center of drive 17 of the focus-direction magnetic circuit of the lens holder 2 falls on a line connecting (a) the middle point 15 between the connection points 13a and 13c with (b) the middle point (not shown) between the connection points 13b and 13d.

In the present embodiment, the supporting wires 3a (3b) and 3c (3d) are connected to the connecting parts 7a and 7b provided on both the longitudinal side surfaces of the lens holder 2, respectively. However, the present invention is not limited to this. That is, the supporting wires 3a, 3b, 3c, and 3d may be arranged so as to be connected directly to the lens holder 2. Further, in the present embodiment, the supporting wires 3a, 3b, 3c, and 3d are provided so as to be parallel to one another. However, the supporting wires 3a, 3b, 3c, and 3d may be arranged so as to intersect with one another as described in Japanese Unexamined Patent Publication No. 77153/2003 (Tokukai 2003-77153; published on Mar. 14, 2003).

The objective lens driving device 1 of the present embodiment is arranged most preferably such that the center of gravity 12 of the lens holder 2 corresponds to the center of drive 17 of the focus-direction magnet circuit. With the arrangement, the objective lens driving device 1 makes it possible that the lens holder 2 is restrained from tilting when the lens holder 2 is in its rest position and when the lens holder 2 is moved in a focus direction.

In order to match the center of gravity 12 of the lens holder 2 with the center of drive 17 of the focus-direction magnet circuit, it is necessary to adjust the position of the center of gravity 12 of the lens holder 2 with respect to the center of drive 17 of the focus-direction magnet circuit. This is attained by (i) changing the shape of the lens holder 2 or (ii) providing the lens holder 2 with a weight. However, the adjustment of the position of the center of gravity 12 of the lens holder 2 is troublesome and expensive.

The aforementioned arrangement in which the supporting wires 3a (3b) and 3c (3d) are respectively connected to the connecting parts 7a and 7b in consideration of the center of gravity 12 of the lens holder 2 or the center of drive 17 of the focus-direction magnetic circuit is less capable of restraining a tilt of the lens holder 2 than the arrangement in which the center of gravity 12 of the lens holder 2 corresponds to the center of drive 17 of the focus-direction magnetic circuit. However, the aforementioned arrangement makes it unnecessary to adjust the position of the center of gravity 12 of the lens holder 2, and makes it possible to easily and inexpensively restrain a tilt of the lens holder 2.

As described above, in the objective lens driving device 1 of the present embodiment, each of the supporting wires 3a, 3b, 3c, and 3d has at least one bent portion bent in different axial direction so as to be included in a flat surface parallel to a flat surface including an optical axis of the objective lens. Therefore, when the lens holder 2 is moved in a focus direction, compressive stress and tensile stress are exerted on the supporting wires 3a, 3b, 3c, and 3d, and are converted into bending stress at the respective bent portions. Then, the angle of each of the respective bent portions of the supporting wires 3a, 3b, 3c, and 3d is changed.

In the foregoing arrangement, each of the supporting wires 3a, 3b, 3c, and 3d is bent at least one portion in a focus direction, so that the compressive stress and the tensile stress each exerted on the supporting wires 3a, 3b, 3c, and 3d are concentrated at the respective bent portions and converted into bending stress. Therefore, the angle of each of the bent portions is changed, so that each of the supporting wires 3a, 3b, 3c, and 3d can be prevented from being unevenly bent at a portion other than the bent portion. As a result, a tangential tilt of the lens holder 2 can be prevented.

The present invention is not limited to the description of the embodiments above, but may be altered by a skilled person within the scope of the claims. An embodiment based on a proper combination of technical means disclosed in different embodiments is encompassed in the technical scope of the present invention.

Further, the objective lens driving device of the present invention may be arranged so that: the elastic member includes two pairs of first second elastic members; and each of the first elastic members and each of the second elastic members are bent face to face with each other in the direction of the optical axis of the objective lens, respectively.

With the arrangement, as compared with a case where the first and second elastic members are bent only in the same way, the lens holder can be moved more stably in both the directions of the optical axis of the objective lens. In the case where the first and second elastic members are bent only in the directions of the optical axis, compressive stress or tensile stress is exerted on the first and second elastic members when the lens holder is moved in the direction of the optical axis of the objective lens. The compressive stress is converted into bending stress for reducing the angel of the bent portion of each of the first and second elastic members. Otherwise, the tensile stress is converted into bending stress for increasing the angle of the bent portion of each of the first and second elastic members.

On the other hand, in the present invention, compressive stress or tensile stress is exerted on each of the first and second elastic members when the lens holder is moved in either of the directions of the optical axis of the objective lens. The compressive stress is converted into bending stress for reducing the angle of the bent portion, and the tensile stress is converted into bending stress for increasing the angle of the bent portion. With the arrangement, as compared with the case where the first and second elastic members are bent only in the same way, the lens holder can be moved in both the directions of the optical axis of the objective lens by substantially uniform stress. Therefore, the lens holder can be moved stably from its rest position in both the directions of the optical axis of the objective lens.

Further, the objective lens driving device of the present invention may be arranged so that when the lens holder is in a rest position in which the lens holder is positioned while the lens holder is not driven, the first and second elastic members have respective bent portions whose angles are equal to each other.

The foregoing arrangement makes it possible that: in cases where the lens holder is moved in both the directions of the optical axis of the objective lens, compressive stress or tensile stress is exerted on the first and second elastic members, and is uniformly converted into bending stress at the respective bent portions.

When the lens holder is moved in one of the directions of the optical axis of the objective lens, compressive stress is exerted on the first elastic members and converted into bending stress for reducing the angle of each of the respective bent portions of the first elastic members, and tensile stress is exerted on the second elastic members and converted into bending stress for increasing the angle of each of the respective bent portions of the second elastic members. On the other hand, when the lens holder is moved in the other direction of the optical axis of the objective lens, compressive stress is exerted on the second elastic members and converted into bending stress for reducing the angle of each of the respective bent portions of the second elastic members, and tensile stress is exerted on the first elastic members and converted into bending stress for increasing the angle of each of the respective bent portions of the first elastic members.

Thus, the lens holder can be moved in both the directions of the optical axis of the objective lens by substantially uniform stress. Therefore, the lens holder can be moved stably from its rest position by substantially equal distances in both the directions of the optical axis of the objective lens.

Further, the objective lens driving device of the present invention may be arranged so that when the lens holder is in a rest position in which the lens holder is positioned while the lens holder is not driven, the first and second elastic members have respective bent portions whose angles are 90°.

According to the arrangement, in cases where the lens holder is moved in both the directions of the optical axis of the objective lens, compressive stress or tensile stress is exerted on the first and second elastic members, and is uniformly converted into bending stress at the respective bent portions.

When each of the bent portions is set to have an acute angle of more than 90°, the compressive stress exerted on the first or second elastic member can be easily converted into bending stress at the bent portion. However, it is difficult that the tensile stress exerted on the first or second elastic member is converted into bending stress at the bent portion.

When each of the bent portions is set to have an obtuse angle of less than 90°, the tensile stress exerted on the first or second elastic member can be easily converted into bending stress at the bent portion. However, it is difficult that the compressive stress exerting on the first or second elastic member is converted into bending stress at the bent portion.

Thus, each of the respective bent portions of the first and second elastic members is set to have an angle of approximately 90°, so that the compressive stress or tensile stress exerted on the first and second elastic members can be easily converted into bending stress at the respective bent portions. Therefore, the objective lens driving device of the present invention makes it possible that the lens holder is moved stably from its rest position by substantially equal distances in both the directions of the optical axis of the objective lens.

Further, the objective lens driving device of the present invention may be arranged so that: the first elastic members are connected to the lens holder at first connection points, respectively; and the second elastic members are connected to the lens holder at second connection points, respectively; and a center of gravity of the lens holder falls on a line connecting (i) a middle point of a line connecting the first and second connection points of one pair, to (ii) a middle point of a line connecting the first and second connection points of the other pair.

When unnecessary moment is exerted on the lens holder that is in its rest position, a tilt of the lens holder is caused. The tilt of the lens holder makes it impossible that: when the lens holder is moved in the direction of the optical axis of the objective lens, compressive stress and tensile stress are exerted on the elastic members, and are converted into bending stress at the respective bent portions.

For example, consider a case where there is no balance of moment among (i) the force by which the first elastic members support the lens holder at the first connection points respectively, (ii) the force by which the second elastic members support the lens holder at the second connection points respectively, and (iii) the gravity exerted on the center of gravity of the lens holder. In this case, the lens holder that is in its rest position tilts in the direction in which the lens holder rotates with respect to the optical axis of the objective lens.

Therefore, it is preferable that the first elastic members and the second elastic members be provided in the lens holder so that a balance of moment is kept among (i) the force by which the first elastic members support the lens holder at the first connection points respectively, (ii) the force by which the second elastic members support the lens holder at the second connection points respectively, and (iii) the gravity exerted on the center of gravity of the lens holder.

In the present invention, the first elastic members and the second elastic members are provided in the lens holder so that the center of gravity of the lens holder falls on the line connecting (i) the middle point of the line connecting the first and second connection points of the one pair, to (ii) the middle point of the line connecting the first and second connection points of the other pair. With this, a balance of moment is kept among (a) the force by which the first elastic members support the lens holder at the first connection points respectively, (b) the force by which the second elastic members support the lens holder at the second connection points respectively, and (c) the gravity exerted on the center of gravity of the lens holder. As a result, no unnecessary moment is exerted on the lens holder, so that the lens holder can be prevented from tilting in the direction in which the lens holder rotates with respect to the optical axis of the objective lens.

Further, the objective lens driving device of the present invention may be arranged so that: the first elastic members are connected to the lens holder at first connection points, respectively; and the second elastic members are connected to the lens holder at second connection points, respectively; and a center of drive of the driving means falls on a line connecting (i) a middle point of a line connecting the first and second connection points of one pair, to (ii) a middle point of a line connecting the first and second connection points of the other pair.

When moving the lens holder in either of the directions of the optical axis of the objective lens, the driving force for the moving is exerted on the center of drive of the driving means, which serves to cause the lens holder to move in the direction of the optical axis of the objective lens. Therefore, for example, unless a balance of moment is kept among (i) the force by which the first elastic members support the lens holder at the first connection points respectively, (ii) the force by which the second elastic members support the lens holder at the second connection points respectively, and (iii) the driving force exerted on the center of drive, the lens holder being moved in the direction of the optical axis of the objective lens tilts in the direction in which the lens holder rotates with respect to the optical axis of the objective lens.

However, according to the present invention, the first elastic members and the second elastic members are provided so that the center of drive of the driving means falls on the line connecting (i) the middle point of the line connecting the first and second connection points of the one pair, to (ii) the middle point of the line connecting the first and second connection points of the other pair. Therefore, no unnecessary moment is exerted on the lens holder being moved in the direction of the optical axis of the objective lens, so that it is possible to prevent the lens holder from tilting in the direction in which the lens holder rotates with respect to the direction of the optical axis of the objective lens.

Further, the objective lens driving device of the present invention may be arranged so that: the first elastic members are connected to the lens holder at first connection points, respectively; and the second elastic members are connected to the lens holder at second connection points, respectively; and a center of gravity of the lens holder falls on a line connecting (i) a middle point of a line connecting the first connection points, to (ii) a middle point of a line connecting the second connection points.

When unnecessary moment is exerted on the lens holder that is in its rest position, a tilt of the lens holder is caused. The tilt of the lens holder makes it difficult that: when the lens holder is moved in the direction of the optical axis of the objective lens, compressive stress and tensile stress are exerted on the first and second elastic members, and are converted into bending stress at the respective bent portions.

For example, unless a balance of moment is kept among (i) the force by which the one pair of first and second elastic members support the lens holder at the first and second connection points respectively, (ii) the force by which the other pair of first and second support the lens holder at the first and second connection points respectively, and (iii) the gravity exerted on the center of gravity of the lens holder, the lens holder that is in its rest position tilts in the direction in which the lens holder rotates on an axis perpendicular to the optical axis of the objective lens.

In the present invention, the first elastic members and the second elastic members are provided so that the center of gravity of the lens holder falls on a line connecting (i) a middle point of a line connecting the first connection points, to (ii) a middle point of a line connecting the second connection points.

With the foregoing arrangement, a balance of moment is kept among (i) the force by which the one pair of first and second elastic members support the lens holder, (ii) the force by which the other pair of first and second elastic members support the lens holder, and (iii) the gravity exerted on the center of gravity of the lens holder. Therefore, no unnecessary moment is exerted on the lens holder, so that the lens holder can be prevented from tilting in the direction in which the lens holder rotates on an axis perpendicular to the optical axis of the objective lens.

Further, according to the foregoing arrangement, a balance of moment is kept among (i) the force by which the first elastic members support the lens holder at the first connection points respectively, (ii) the force by which the second elastic members support the lens holder at the second connection points respectively, and (iii) the gravity exerted on the center of gravity of the lens holder. In addition, a balance of moment is kept among (a) the force by which the one pair of first and second elastic members support the lens holder at the first and second connection points respectively, (b) the force by which the other pair of first and second elastic member support the lens holder at the first and second connection points respectively, and (c) the gravity exerted on the center of gravity of the lens holder.

Therefore, the lens holder can be prevented from tilting (i) in the direction in which the lens holder rotates with respect to the direction of the optical axis of the objective lens and (ii) in the direction in which the lens holder rotates on an axis perpendicular to the optical axis of the objective lens.

Further, the objective lens driving device of the present invention may be arranged so that: the first elastic members are connected to the lens holder at first connection points, respectively; and the second elastic members are connected to the lens holder at second connection points, respectively; and a center of drive of the driving means falls on a line connecting (i) a middle point of a line connecting the first connection points, to (ii) a middle point of a line connecting the second connection points.

When the lens holder is moved in the direction of the optical axis of the objective lens, the driving force to cause the lens holder to move is exerted on the center of drive of the driving means for causing the lens holder to move in the direction of the optical axis of the objective lens.

Therefore, for example, unless a balance of moment is kept among (i) the force by which the one pair of first and second elastic members support the lens holder at the first and second connection points respectively, (ii) the force by which the other pair of first and second elastic members support the lens holder at the first and second connection points respectively, and (iii) the driving force exerted on the center of drive of the driving means, the lens holder being moved in the direction of the optical axis of the objective lens tilts in the direction in which the lens holder rotates on an axis perpendicular to the optical axis of the objective lens.

In light of this, according to the present invention, the first elastic members and the second elastic members are provided so that the center of drive of the driving means falls on the line connecting (i) the middle point of the line connecting the first connection points, to (ii) the middle point of the line connecting the second connection points. Therefore, no unnecessary moment is exerted on the lens holder, so that the lens holder can be prevented from tilting in the direction in which the lens holder rotates on an axis perpendicular to the optical axis of the objective lens.

Further, according to the present invention, a balance of moment is kept among (i) the force by which the first elastic members support the lens holder at the first connection points respectively, (ii) the force by which the second elastic members support the lens holder at the second connection points respectively, and (iii) the driving force exerted on the center of drive of the driving means when the lens holder is moved in the direction of the optical axis of the objective lens by the driving means. In addition, a balance of moment is kept among (a) the force by which the one pair of first and second elastic members support the lens holder at the first and second connection points respectively, (b) the force by which the other pair of first and second elastic members support the lens holder at the first and second connection points respectively, and (c) the driving force exerted on the center of drive of the driving means when the lens holder is moved in the direction of the optical axis of the objective lens by the driving means.

Therefore, the lens holder can be prevented from tilting (i) in the direction in which the lens holder rotates with respect to the direction of the optical axis of the objective lens and (ii) in the direction in which the lens holder rotates on an axis perpendicular to the optical axis of the objective lens.

Further, the objective lens driving device of the present invention may be arranged so that: the first elastic member has a portion extending from the supporting substrate to a bent portion of the first elastic member, and the portion has a length different from a length of a portion, which extends from the supporting substrate to a bent portion of the second elastic member, of the second elastic member.

A light spot for information recording or information reproducing is focused on one optical information recording medium when a lens holder is positioned at a certain height, and a light spot therefor is focused on another optical information recording medium when the lens holder is positioned at a different height. In cases where the length of the portion of the first elastic member which portion extends from the supporting substrate to the bent portion of the first elastic member is equal to the length of the portion of the second elastic member which portion extends from the supporting substrate to a bent portion of the second elastic member, the rest position of the lens holder is a position most appropriate for focusing of a light spot. Therefore, in cases where there is a big difference between (i) the rest position of the lens holder and (ii) a position to which the lens holder is moved so that a light spot is focused on an optical information recording medium, it is difficult to stably move the lens holder.

In light of this, according to the present invention, the portion of the first elastic member which portion extends from the supporting substrate to the bent portion of the first elastic member is different in length from the portion of the second elastic member which portion extends from the supporting substrate to the bent portion of the second elastic member. Therefore, even when there is a big difference between (i) the rest position of the lens holder and (ii) a position to which the lens holder is moved so that a light spot is focused on an optical information recording medium, it is possible to stably move the lens holder.

An optical pickup apparatus of the present invention is arranged so as to include the objective lens driving device of any one of the foregoing arrangements.

The foregoing arrangement makes it possible to obtain an optical pickup apparatus including an objective lens driving device in which a lens holder is restrained from tilting when the lens holder is moved in the direction of the optical axis of an objective lens.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. An objective lens driving device, comprising:
a lens holder, which holds an objective lens that converges light of a light source on a recording surface of an optical information recording medium so that information is recorded or reproduced;
a bar-like elastic member, which connects the lens holder to a supporting substrate; and
driving means, which changes a position of the lens holder relative to the supporting substrate by applying force to the lens holder in either of directions of an optical axis of the objective lens in order to cause the elastic member to be elastically deformed in a bending direction,
the elastic member having at least one bent portion extending in different axial directions, the elastic member being included in a flat surface parallel to a flat surface including the optical axis of the objective lens.

2. The objective lens driving device as set forth in claim 1, wherein:
the elastic member includes two pairs of first and second elastic members; and
each of the first elastic members and each of the second elastic members are bent face to face with each other in the directions of the optical axis of the objective lens, respectively.

3. The objective lens driving device as set forth in claim 2, wherein when the lens holder is in a rest position in which the lens holder is positioned while the lens holder is not driven, the first elastic member and the second elastic member have respective bent portions whose angles are equal to each other.

4. The objective lens driving device as set forth in claim 2, wherein when the lens holder is in a rest position in which the lens holder is positioned while the lens holder is not driven, the first elastic member and the second elastic member have respective bent portions whose angles are 90°.

5. The objective lens driving device as set forth in claim 2, wherein:
the first elastic members are connected to the lens holder at first connection points, respectively; and
the second elastic members are connected to the lens holder at second connection points, respectively; and
a center of gravity of the lens holder falls on a line connecting (i) a middle point of a line connecting the first and second connection points of one pair, to (ii) a middle point of a line connecting the first and second connection points of the other pair.

6. The objective lens driving device as set forth in claim 2, wherein:
the first elastic members are connected to the lens holder at first connection points, respectively; and
the second elastic members are connected to the lens holder at second connection points, respectively; and
a center of drive of the driving means falls on a line connecting (i) a middle point of a line connecting the first and second connection points of one pair, to (ii) a middle point of a line connecting the first and second connection points of the other pair.

7. The objective lens driving device as set forth in claim 2, wherein:
the first elastic members are connected to the lens holder at first connection points, respectively; and
the second elastic members are connected to the lens holder at second connection points, respectively; and
a center of gravity of the lens holder falls on a line connecting (i) a middle point of a line connecting the first connection points, to (ii) a middle point of a line connecting the second connection points.

8. The objective lens driving device as set forth in claim 2, wherein:
the first elastic members are connected to the lens holder at first connection points, respectively; and
the second elastic members are connected to the lens holder at second connection points, respectively; and
a center of drive of the driving means falls on a line connecting (i) a middle point of a line connecting the first connection points, to (ii) a middle point of a line connecting the second connection points.

9. The objective lens driving device as set forth in claim 2, wherein the first elastic member has a portion extending from the supporting substrate to a bent portion of the first elastic member, and the portion has a length different from a length of a portion, which extends from the supporting substrate to a bent portion of the second elastic member, of the second elastic member.

10. An optical pickup apparatus, comprising the objective lens driving device as set forth in claim 1.
